(19) United States
(12) Patent Application Publication
(10) Pub. No.: US 2014/0298097 A1
(43) Pub. Date: Oct. 2, 2014

(54) SYSTEM AND METHOD FOR CORRECTING OPERATIONAL DATA

(71) Applicant: GENERAL ELECTRIC COMPANY, Schenectady, NY (US)

(72) Inventors: Kati Illouz, Schenectady, NY (US); Brock Estel Osborn, Niskayuna, NY (US)

(73) Assignee: General Electric Company, Schenectady, NY (US)

(21) Appl. No.: 13/852,632

(22) Filed: Mar. 28, 2013

(51) Int. Cl. G06F 11/34

(52) U.S. Cl. CPC G06F 11/3452
USPC 714/37

(57) ABSTRACT

A method implemented using a processor based device for generating a corrected data for deriving a decision related to a data source includes receiving measurement data representative of an operational parameter from the data source. The operational parameter includes a monotonous time series data. The method also includes identifying an event based on the measurement data and determining an event category based on the identified event. The method further includes processing the measurement data using a statistical data correction technique, based on the determined event category, to generate the corrected data for deriving the decision related to the data source.

### BACKGROUND

The subject matter disclosed herein, generally relates to processing of time series data. More specifically, the subject matter relates to correcting errors of monotonically non-decreasing operational data of a data source, for example a locomotive.

Locomotives, for example are complex electromechanical systems. A typical locomotive is equipped with one or more sensors to measure operational parameters of the locomotive. Continuously monitoring and recording of the operational parameters of the locomotive helps in many ways. The operational parameters that may be monitored include, but not limited to, speed, braking times, fuel consumption, mileage, distance traveled, power requirement in terms of KWh. Analysis of such data enables the customers to implement cost-effective maintenance schemes.

Several errors may be observed in the measured operational data and hence such errors need to be corrected for effective utilization. Observed errors in the measured operational data are due to, but not limited to, faulty sensors, switching of cab panels, and electronic errors. Systematic identification and documentation of the data errors are required to investigate the root causes responsible for generating inaccurate data within the locomotive panel readings. Conventionally, correction of errors of the received operational data is performed by manual processing. The manual processing is extensively labor intensive and not easily repeatable on additional data. Locomotive operational data is classified and hence, in-house processing of the measured data may be preferable and outsourcing of manual operation may not be an available option. Also, devising of newer techniques for processing of locomotive operational data requires access to a vast amount of locomotive operational data during design and validation phases.

An enhanced technique for correcting the operational data of a data source is desirable.

### BRIEF DESCRIPTION

In accordance with one aspect of the present technique, a method for generating a corrected data for deriving a decision related to a data source is disclosed. The method includes receiving measurement data representative of an operational parameter from the data source. The operational parameter includes a monotonous time series data. The method also includes identifying an event based on the measurement data and determining an event category based on the identified event. The method further includes processing the measurement data using a statistical data correction technique, based on the determined event category, to generate the corrected data for deriving the decision related to the data source.

In accordance with another aspect of the present technique, a system for generating a corrected data for deriving a decision related to a data source is disclosed. The system includes a processor based device configured to receive measurement data representative of an operational parameter from the data source. The operational parameter includes a monotonous time series data. The processor based device is further configured to identify an event based on the measurement data and to determine an event category based on the identified event. The processor based device is further configured to process the measurement data using a statistical data correction technique, based on the determined event category, to generate the corrected data for deriving the decision related to the data source.

In accordance with another aspect of the present technique, a non-transitory computer readable medium encoded with a program to instruct a processor based device for generating a corrected data for deriving a decision related to a data source is disclosed. The program instructs the processor based device to receive measurement data representative of an operational parameter from the data source. The operational parameter includes a monotonous time series data. The program further instructs the processor based device to identify an event based on the measurement data and to determine an event category based on the identified event. The program also instructs the processor based device to process the measurement data using a statistical data correction technique, based on the determined event category, to generate the corrected data for deriving the decision related to the data source.

### DRAWINGS

These and other features and aspects of embodiments of the present invention will become better understood when the following detailed description is read with reference to the accompanying drawings in which like characters represent like parts throughout the drawings, wherein:

FIG. 1 is a diagrammatic illustration of a system used for correcting measurement data representative of an operational parameter of a data source, for example a locomotive in accordance with an exemplary embodiment;

FIG. 2 is a graph illustrating a curve indicative of measurement data representative of an operational parameter of a data source in accordance with an exemplary embodiment;

FIG. 3 is a graph illustrating a curve representative of a first derivative of the measurement data represented in FIG. 2 in accordance with an exemplary embodiment;

FIG. 4 is a graph depicting a curve representative of identification an event based on a threshold value in accordance with an exemplary embodiment;

FIG. 5 illustrates a curve indicative of a secant line corresponding to an identified event in accordance with an exemplary embodiment;

FIG. 6 is a table showing a record of events associated with an operational parameter in accordance with an exemplary embodiment;

FIG. 7 is a graph illustrating a curve indicative of correction of a self-correcting event in accordance with an exemplary embodiment;

FIG. 8 is a graph illustrating a curve indicative of correction of a non-correcting event in accordance with an exemplary embodiment;

FIG. 9 is a graph illustrating a curve representative of measurement data having a date error event, a self-correcting event and a non-correcting event in accordance with an exemplary embodiment;

FIG. 10 illustrates a graph depicting a corrected measurement data in accordance with an exemplary embodiment of FIG. 9;

FIG. 11 is a graph illustrating a curve representative of mileage of a data source having an erroneous intercept event in accordance with an exemplary embodiment;

FIG. 12 is a graph illustrating a curve indicative of an applied correction to the intercept event in accordance with an exemplary embodiment of FIG. 11; and

FIG. 13 is a flow chart illustrating steps involved in a statistical data correction technique for correcting measurement data representative of an operational parameter of a data source, for example, a locomotive in accordance with an exemplary embodiment.

### DETAILED DESCRIPTION

Embodiments of the present invention relate to a statistical data correction technique applied to a measurement data received from a data source to generate a corrected data for deriving a decision related to the data source. The measurement data is a monotonically non-decreasing time series data representative of an operational parameter of the data source. An event is identified from the received measurement data based on a signal representative of a first derivative of the received measurement data. An event category is determined based on the identified event. The received measurement data is processed using a statistical data correction technique, based on the determined event category, to generate a corrected data.

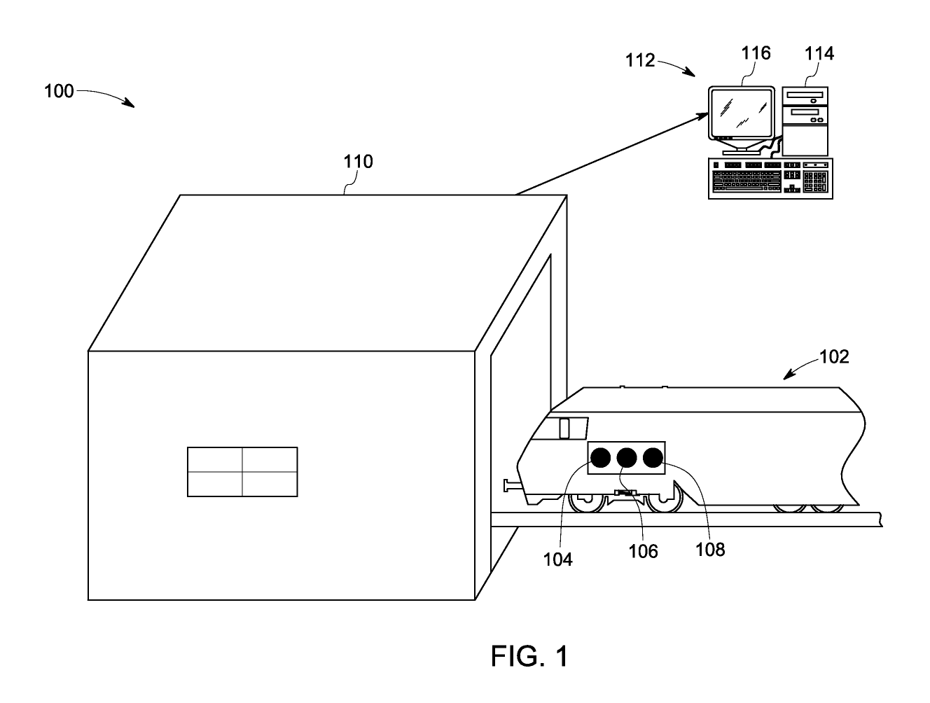

FIG. 1 is a diagrammatic illustration of a system 100 for correcting measurement data representative of an operational parameter using a statistical data correction technique in accordance with an exemplary embodiment. The system 100 includes a data source 102 having a plurality of sensors 104, 106, 108 for measuring data representative of operational parameters of the data source 102. In the illustrated embodiment, the data source 102 is a self-propelled vehicle such as a locomotive or an engine. In other embodiments, other types of data sources are also envisioned. In the illustrated embodiment, the sensor 104 is used to measure mileage of the data source 102, and the sensor 106 is used for recording idle-hours of the data source 102. The sensor 108 is used to measure cumulative consumed power of the data source 102. In other embodiments, additional sensors may be used in the system 100 when more operational parameters of the data source 102 are to be monitored. Any monotonically non-decreasing operational parameter of the data source 102 may be measured by employing suitable type of sensors. The operational parameter may be a non-decreasing time series data or a weak non-decreasing time series data that may include same values at successive time instants. Although, various embodiments described herein are related to the non-decreasing operational parameters, the exemplary techniques are also applicable to non-increasing time series data or to a weak non-increasing time series data representing the operational parameters. It should be noted herein that, a monotonous time series data may be referred to as a non-decreasing time series data, or a weak non-decreasing time series data, or a non-increasing time series data, or a weak non-increasing time series data. The examples discussed herein should not to be construed as a limitation of the invention. The system 100 further includes a data collection center 110 for receiving the measured operational parameters by the sensors 104, 106, 108. In the illustrated embodiment, the data collection center 110 may be a service center where routine repair and maintenance of the data source 102 is performed once in few months. In other embodiments, the data collection center 110 may be a data logger, a data base remotely connected to the data source 102 through a wireless link or the like. The measured operational parameters are retrieved at the data collection center 110. The date of retrieval of measurement data at the data collection center 110 is referred herein as a data retrieval date. The measurement data is processed by a computer system 112 having a processor based device 114, using a statistical data correction technique to generate a corrected data for deriving a decision related to the data source 102. The computer system 112 may also have other components such as a display 116 and other devices for easy interaction with the processor based device 114.

The processor based device 114 may include a controller, a general purpose processor, or a Digital Signal Processor (DSP). The processor based device 114 may receive additional inputs from a user through a control panel or any other input device such as a keyboard of the computer system 112. The processor based device 114 is configured to access computer readable memory modules including, but not limited to, a random access memory (RAM), and read only memory (ROM) modules. The memory medium may be encoded with a program to instruct the processor based device 114 to enable a sequence of steps to correct errors in the measurement data measured by the sensors 104, 106, 108. In one embodiment the computer system 112 may be a standalone system and may be communicatively coupled to the data collection center 110. In another embodiment, the computer system 112 may be part of the data collection center 110.

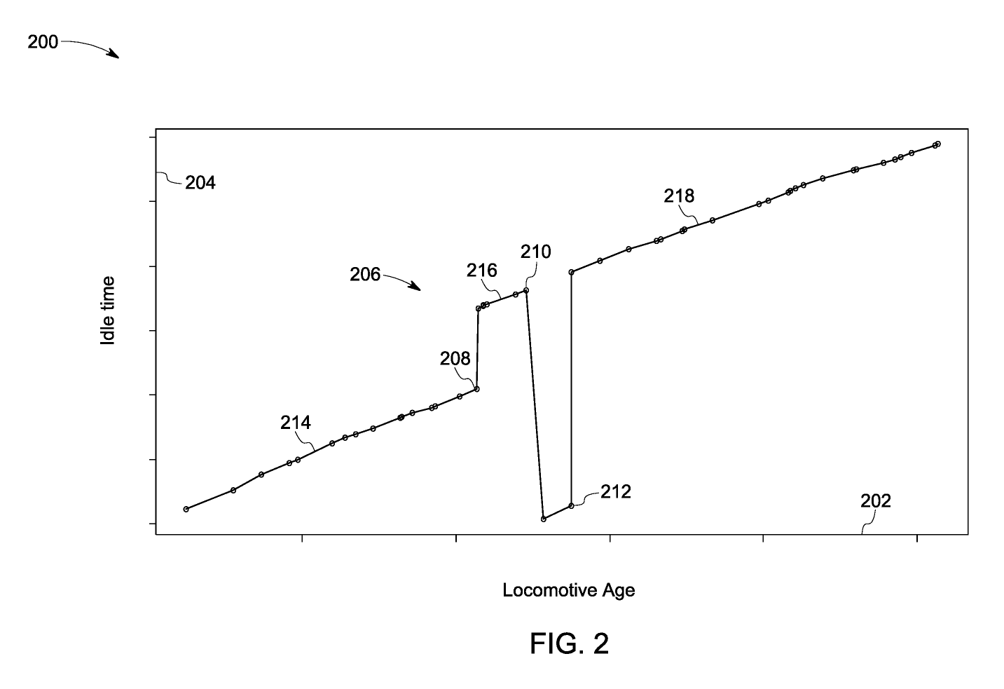

FIG. 2 is a graph 200 of an operational parameter from the data source in accordance with an exemplary embodiment. The graph 200 illustrates a curve 206 representative of measurement data. In the illustrated embodiment, data source is a locomotive and the measurement data is representative of idle hours of the locomotive. The x-axis 202 of the graph 200 is representative of age of the locomotive in days and the y-axis 204 is time in hours representative of idle time of the data source. The curve 206 exhibits a linear trend line 214 till a data sample 208 where there is a discontinuity. The discontinuity at the data sample 208 in the curve 206 is referred to as an event. Specifically, the event manifests as a sudden increase in the value of the measurement data and such a discontinuity is referred to as a “rise” event or as a “jump” event. Similarly, the curve 206 exhibits another discontinuity at a data sample 210 manifested as a sudden decrease in the value of the measurement data. The discontinuity at the data sample 210 is also an event and is referred to as a “fall” event. Both types of discontinuities, the rise event at the data sample 208 and the fall event at the data sample 210 are commonly referred to as “shift” events. A shift event is discussed herein by referring to at least to one of a data sample of the measurement data at which a discontinuity occurs, and a time instant associated with the data sample. The graph 200 illustrates another discontinuity at a data sample 212 which is a shift event (in particular a rise event). It should be noted herein that the terms “shift event” and “shift” may be used interchangeably in the subsequent paragraphs.

The shift is representative of an error condition in the measurement data. In the illustrated embodiment, the shift at the data sample 208 is classified as a non-correcting shift. After the data sample 208, a new linear trend line 216 is generated different from a linear trend line 214 such that the two linear trend lines 214, 216 are not collinear. The data sample 210 of the illustration is classified as a self-correcting shift. The self-correcting shift generates a linear trend line 218 which is collinear with the linear trend line 216. Techniques for identification, classification, and correction of both non-correcting shift and self-correcting shift are explained in greater detail with reference to subsequent figures.

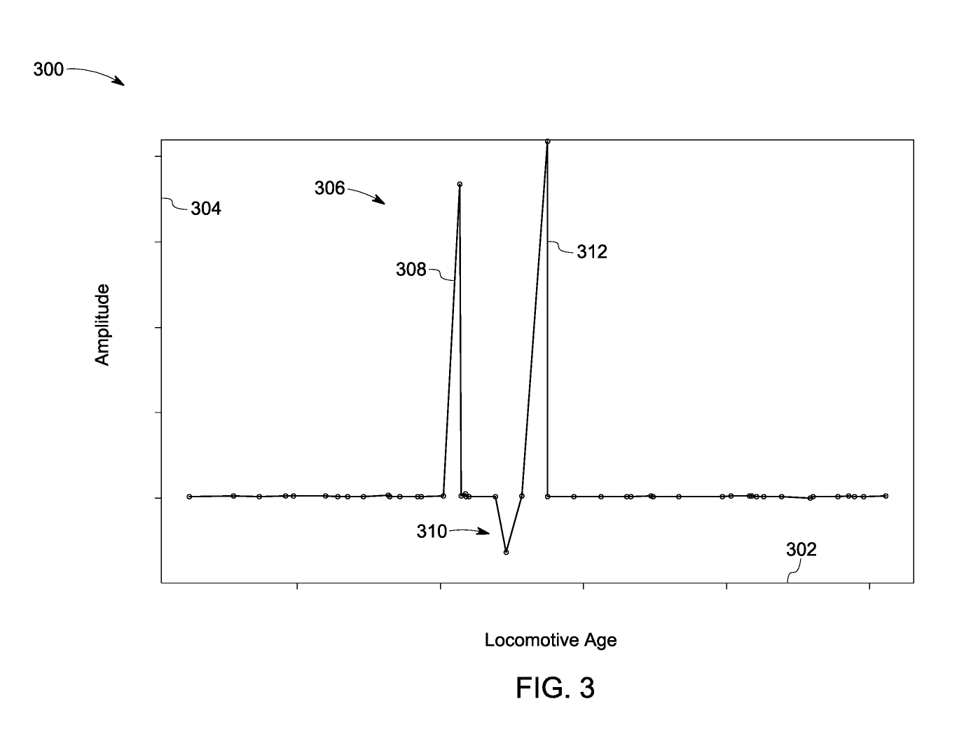

FIG. 3 is a graph 300 illustrating a curve 306 representative of a first derivative of the measurement data represented in FIG. 2, in accordance with an exemplary embodiment. The x-axis 302 of the graph 300 is representative of locomotive age and the y-axis 304 is representative of amplitude of the first derivative of the operational parameter representing idle hours of the locomotive. The curve 306 exhibits two positive peak values 308, 312 and one negative peak value 310. The positive peak value 308 is representative of a first derivative of rise event at the data sample 208 of FIG. 2. The negative peak value 310 is representative of a first derivative of the fall event at the data sample 210 of FIG. 2. The positive peak value 312 is representative of a first derivative of the rise event at the data sample 212 of FIG. 2. It may be observed from the illustrated graph 300 that except at the three peak values 308, 310, 312, the amplitude values of the first derivative of data samples of the measurement data are very small.

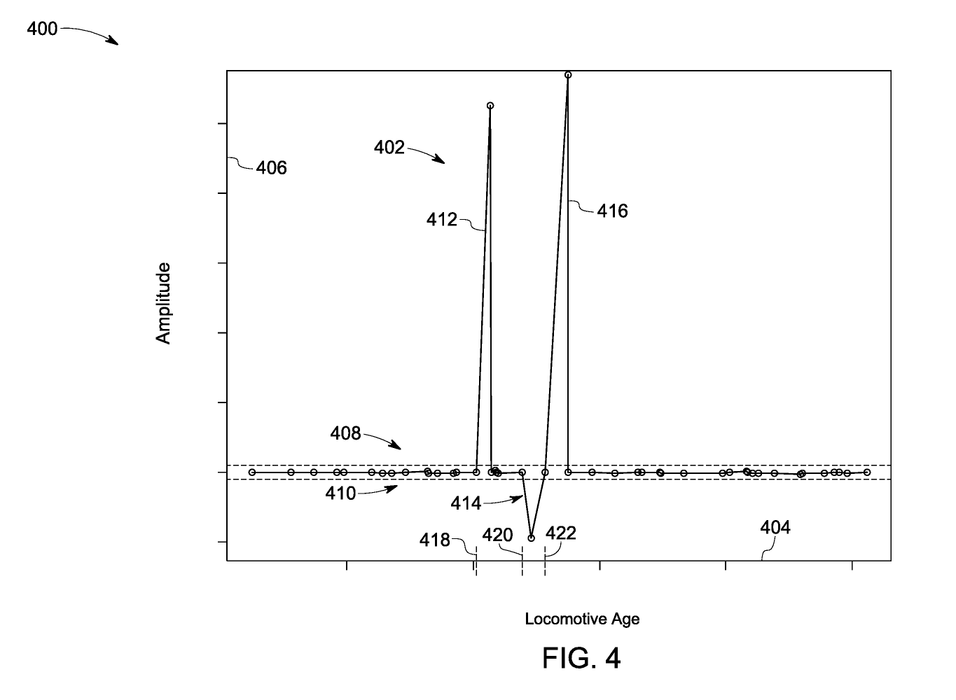

FIG. 4 is a graph 400 depicting a technique for determining an event based on a threshold value in accordance with an exemplary embodiment. The x-axis 404 of the graph 400 is representative of locomotive age and the y-axis 406 is representative of the amplitude of the first derivative of the operational parameter of the locomotive. The graph 400 shows a curve 402 representative of the first derivative of the measurement data represented in FIG. 2, a positive threshold value 408, and a negative threshold value 410 around a first derivative value equal to zero. The curve 402 exhibits two positive peak values 412, 416 of the first derivative and one negative peak value 414. The positive peak value corresponds to shift event at the data sample 208 of FIG. 2, the negative peak value 414 corresponds to shift event at the data sample 210 of FIG. 2, and the positive peak value 416 corresponds to shift event at the data sample 212 of FIG. 2. The positive threshold value 408 and the negative threshold value 410 have the same magnitude equal to a first threshold value. The first derivative at each of the data samples of the curve 402 is compared with the threshold values 408, 410. The time instant at which the value of the first derivative crosses one of the threshold values 408, 410 is identified as an event. For example, the peak value 412 crosses the positive threshold value 408 and hence a corresponding time instant 418 is identified as an event. In another example, the peak value 414 crosses the negative threshold value 410 and a corresponding time instant 420 is identified as another event. As another example, the peak value 416 crosses the positive threshold value 408 and a corresponding time instant 422 is identified as an event. In another exemplary embodiment, instead of using two threshold values, only one threshold value may be used to determine the event. The magnitude of the first derivative value is compared with the positive threshold value 408 and if the magnitude is greater than the positive threshold value 408, an event is determined at a time instant value corresponding to the first derivative value.

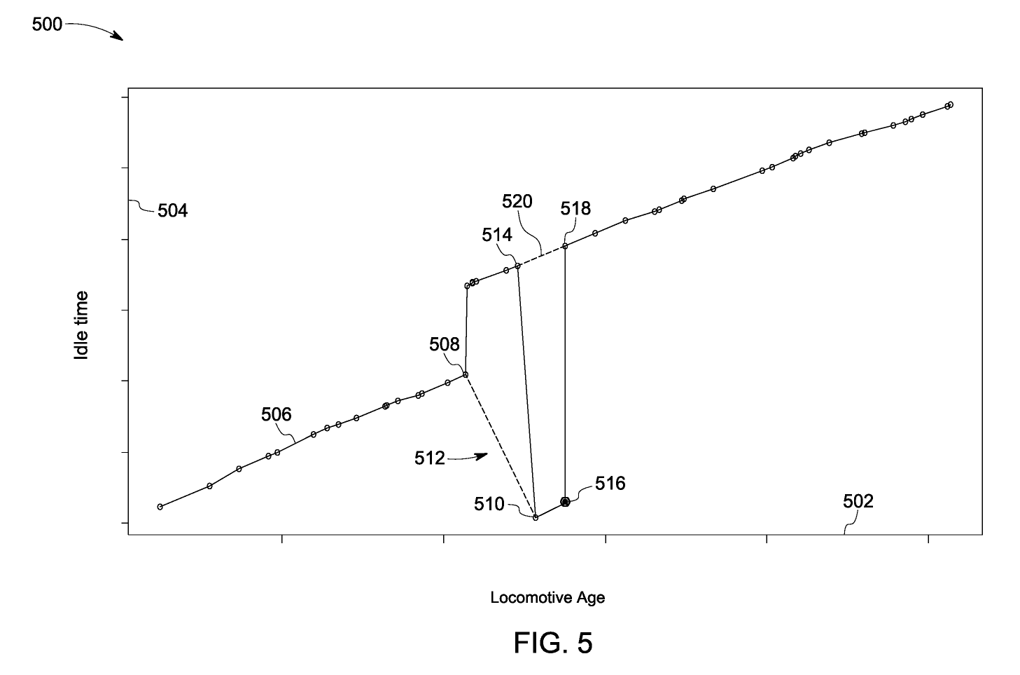

The identified event is indicative of the presence of an error in the measurement data. The error may belong to one among a plurality of categories including a self-correcting event, a non-correcting event, an out of range event, an intercept event and a date error event. The out-of-range event refers to a shift event at the last data sample of the measurement data. The intercept event refers to a deviation of an intercept value of a trend line of the measurement data from an intercept value of an average trend line of a fleet of data sources. A date error event may refer to a missing date, a date after the withdrawal of the data source from service, or to a date before the introduction of the data source into the service. An event category is determined based on the measurement data and the identified event as explained in the next paragraph with reference to FIG. 5.

FIG. 5 is a graph 500 illustrating construction of a secant line for a data sample corresponding to an identified event, for determining an event category of the identified event in accordance with an exemplary embodiment. The x-axis 502 of the graph 500 is representative of the locomotive age and the y-axis 504 of the graph 500 is representative of idle time. The graph 500 has a curve 506 is representative of cumulative idle hours during operation of the locomotive. The graph shows two secant lines 512 and 520 corresponding to two data samples 508 and 514 respectively. The procedure for constructing the secant line 512 with reference to an identified event corresponding to the data sample 508 is explained herein.

The identified event at the data sample 508 is referred to as a first event and the data sample 508 is selected as a “first point” of the measurement data. The identified event at the data sample 514 is referred to as a second event. In the illustrated embodiment, the first event at the data sample 508 and the second event at the data sample 514 are adjacent events. A data sample 510 adjacent to the second event at the data sample 514, is selected as a “second point” of the measurement data. The line joining the first point (the data sample 508) to the second point (the data sample 510) is referred to as the secant line 512. Similarly, the secant line 520 is formed with reference to an identified event corresponding to the data sample 514. For the formation of the secant line 520, the data sample 514 is referred to as a first event and is selected as a “first point”. The identified event at a data sample 516 is referred to as a second event. The first event and the second event at the data samples 514, 516 respectively are mutually adjacent events. A data sample 518 adjacent to the second event at the data sample 516, is selected as a second point. The secant line 520 joins the data sample 514 to the data sample 518. Similarly, a secant line is formed for every identified event of the curve 506.

A slope of a secant line is determined based on the coordinates of the first point and the second point joined by the secant line. For example, if the first point has a value y1 and the second point has a value y2, the slope of the secant line is represented by,

$$sl = ( \frac{{y}_{2} - {y}_{1}}{{t}_{2} - {t}_{1}} ) \qquad ( 1 )$$

where t₂ is the time instant corresponding to the second point and t₁ is the time instant corresponding to the first point.

A score value corresponding to an identified event is determined based on the slope of the secant line corresponding to the identified event. The score value is represented by:

$$score = ( \frac{sl - med}{MAD} ) \qquad ( 2 )$$

Where, sl is representative of a slope of the secant line corresponding to the identified event, med is representative of a median of a plurality of the first derivative values of measurement data, MAD is the median absolute deviation of a plurality of the first derivative values of the measurement data. In the illustrated embodiment, the score value corresponding to the data sample 508 is (−)32.20768 and the score value corresponding to the data sample 514 is (+)0.3259564. It may be noted herein that the magnitude of the score value corresponding to a non-correcting shift is greater compared to the magnitude of the score value corresponding to a self-correcting shift.

The magnitude of the score value determined as explained in the previous paragraph is compared with a second threshold value. If the score value is greater than the second threshold value, the identified event is declared as a non-correcting event. If the score value is smaller than or equal to the second threshold value, the event is declared as a self-correcting event. In one exemplary embodiment, the second threshold value may be equal to the first threshold value. The first threshold value and the second threshold values may be chosen based on at least one of the historical data, and user requirements. In an exemplary embodiment, the first threshold value is determined by empirical methods and the second threshold value is determined based on an average trend line corresponding to a plurality of measurement data.

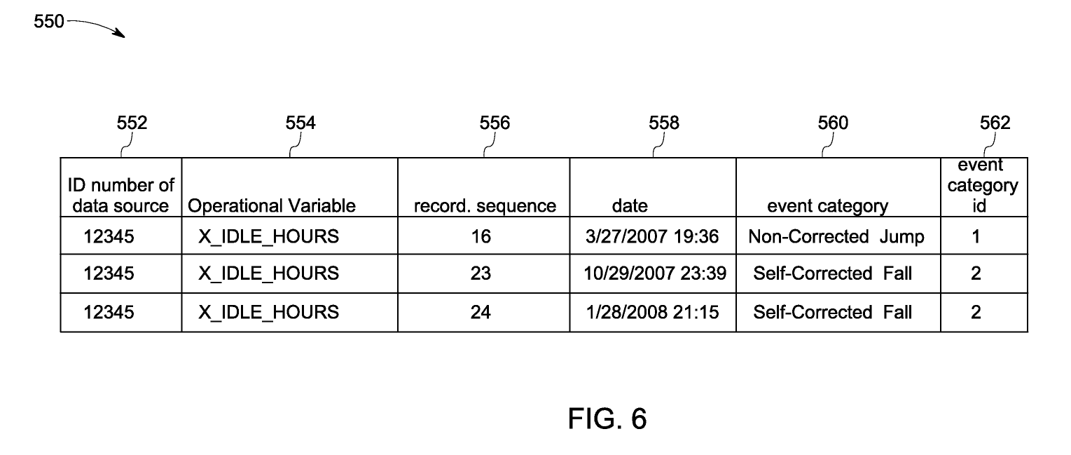

FIG. 6 is a table 550 illustrating a record of events associated with an operational parameter in accordance with an exemplary embodiment. The first column 552 of the table 550 represents identity number of the data source and the second column 554 represents operational variable name. The third column 556 of the table 550 is representative of sequence number of the recorded operational parameter and the fourth column 558 of the table 550 is representative of the date at which the data is recorded. The fifth column 560 of the table 550 represents the event category and the sixth column 562 of the table 550 represents an identity number of the event category of the fifth column 560. The table 550 may be accessed by the processor based device 114 of FIG. 1 and the measurement data of the table is processed to correct errors in the data.

The measurement data may be processed using a statistical data correction technique to generate a corrected data for deriving a decision related to the data source. The statistical data correction technique is based on the determined event category. In one exemplary embodiment, the processing involves removing a discontinuity in the measured data if the determined event category is a non-correcting event. The discontinuity may be removed by aligning two trend lines generated by the non-correcting event to be collinear. In another exemplary embodiment, the processing involves interpolating the measurement data if the determined event category is the self-correcting event. Interpolation refers to an averaging operation performed on a plurality of data samples along a pair of collinear trend lines generated by the self-correcting shift. In another exemplary embodiment, the processing involves extrapolating the measurement data if the determined event category is an out-of-range event. Extrapolation refers to an averaging operation performed on a plurality of data samples along a trend line and extending the trend line to a data sample at which an out-of-range event occurs. If the determined event category is the intercept event, the processing involves replacing the measurement data by a fleet level average data. The fleet level average data may be referred to as an average of a plurality of measurement data of the same operational parameter from a plurality of vehicles operating in a similar environment. In an exemplary embodiment of the processing technique, a date-error event is corrected. The processing of a date-error event involves including at least one of a missing date of operation of the data source, correcting a first date prior to a service introduction date of the data source, and correcting a second date after a service completion date (or data retrieval date) of the data source. For example, if the data source is operating from 1 Jan. 2007, any date entry prior to 1 Jan. 2007 is identified as a date error event. Similarly, for example, if the data source is withdrawn from service from 31 Dec. 2012, date entries after 31 Dec. 2012 are considered as date error events. As another example, if data is retrieved from the data source on 4 May 2010, a date entry after 4 May 2010 is considered as a date error event. When a date entry for a data sample of the measurement data is not available, a missing date of operation is determined to correct the date error event. For example, if a first data sample has a date entry of 1 Mar. 2008 and a second data sample has a date entry of 1 Apr. 2008, a date error event in-between the first data sample and the second data sample is corrected by determining a suitable date in between 1 Mar. 2008 and 1 Apr. 2008.

The decision related to the data source generated by the statistical data correction technique includes, but not limited to, prognostics information about the data source. The decision may also be related to the end of life of one or more individual components of the data source. The decision related to the data source helps to build accurate reliability models that are used in estimating price of maintenance contracts of the data source and to predict the short and long term profitability of offerings from the service provider.

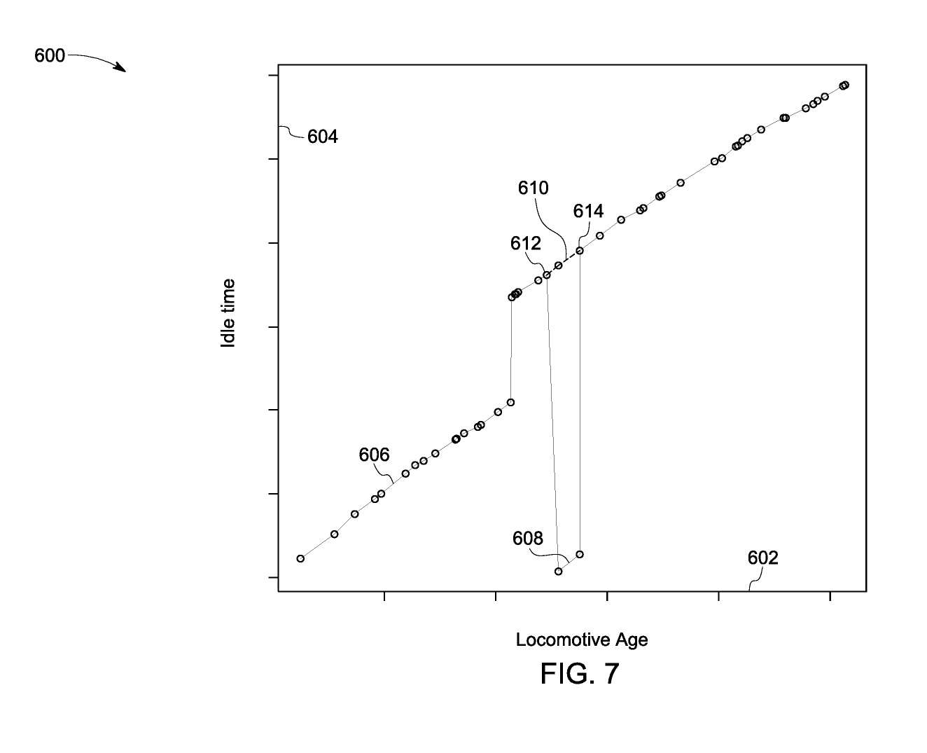

FIG. 7 is a graph 600 showing correction of the measurement data represented in FIG. 2, having a self-correcting event in accordance with an exemplary embodiment. The x-axis 602 of the graph 600 is representative of the locomotive age and the y-axis 604 is representative of idle time. The graph 600 illustrates a curve 606 is representative of accumulated idle hours of the locomotive as an operational parameter. The curve 606 shows a cluster of data samples on a trend line 608 due to a self-correcting shift at a data sample 612. The self-correcting shift at the data sample 612 generates two collinear trend lines i.e. one trend line before the data sample 612 and another trend line after a data sample 614. The processing of the self-correcting shift at the data sample 612 involves interpolation of selected data samples on the curve 606 to generate a trend line 610. The corrected measurement data on a trend line 610 is obtained by interpolating data samples before the data sample 612 and after the data sample 614.

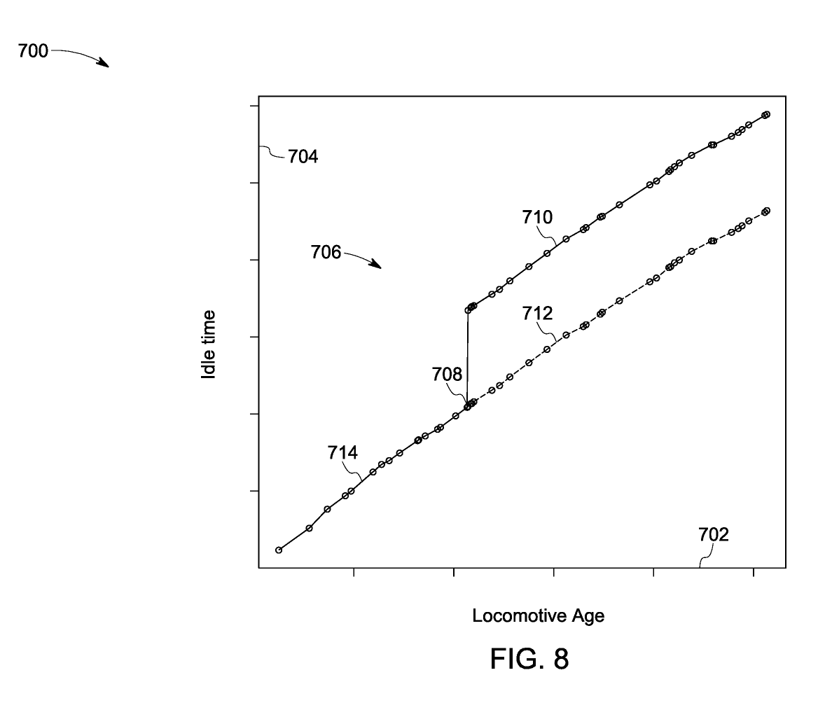

FIG. 8 is a graph 700 showing correction of the measurement data represented in FIG. 2, having a non-correcting event in accordance with an exemplary embodiment. The x-axis 702 of the graph 700 is representative of the locomotive age and the y-axis 704 is representative of idle time in hours. The graph illustrates a curve 706 is representative of accumulated idle hours of the locomotive as an operational parameter. The curve 706 exhibits a shift at a data sample 708 (specifically a rise event) corresponding to a non-correcting event. The portion of the measurement data after the data sample 708 exhibits a linear trend line 710 which is not collinear with a linear trend line 714 before the data sample 708. The processing of a non-correcting shift involves removing a discontinuity occurring at the identified event. The corrected measurement data is obtained by removing the discontinuity at the data sample 708 to generate a linear trend line 712 collinear with the trend line 714.

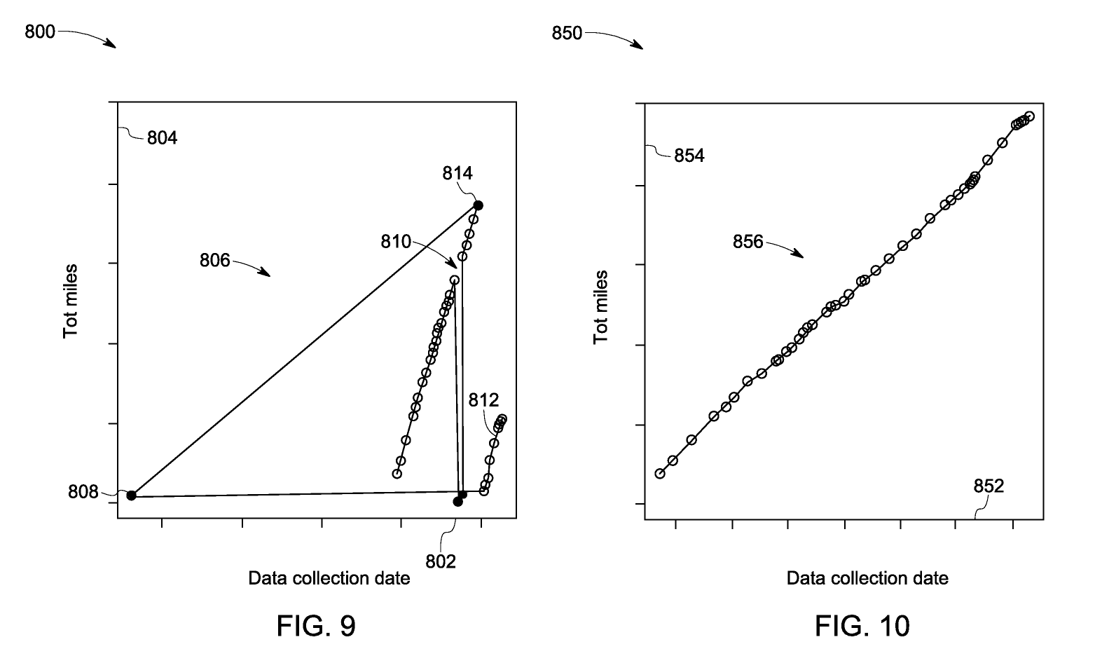

FIG. 9 is a graph 800 illustrating an example of measurement data with date error, self-correcting error and a non-correcting error in accordance with an exemplary embodiment. The x-axis 802 of the graph 800 indicates time representative of the data collection date and the y-axis 804 indicates miles representative of the total miles traveled by a data source. The graph 800 illustrates a curve 806 is representative of mileage information measured as an operational parameter of the data source. A data sample 808 of the curve 806 corresponds to a date error event. In the illustrated embodiment, the data collection date corresponding to the data sample 808 is prior to the in service date of the data source. A shift at a data sample 810 of the curve 806 corresponds to a self-correcting event and a shift at a data sample 814 is representative of a non-correcting event. The date corresponding to the data sample 808 is modified based on the date values associated with data samples before and after the data sample 808. The shift event at the data sample 810 is corrected based on interpolation technique. The shift event at the data sample 814 is corrected by removing the discontinuity at the data sample 814 by aligning a linear trend line 812 to be collinear with the rest of the curve 806.

FIG. 10 is a graph 850 depicting a corrected measurement data of FIG. 9 in accordance with an exemplary embodiment. The x-axis 852 of the graph 850 indicates data collection date and the y-axis 854 represents total miles traveled by the data source. The graph 850 illustrates a curve 856 is representative of mileage data with error corrections applied to the data samples 808, 810, 814 shown in FIG. 9 corresponding to the date error event, the self-correcting event, and the non-correcting event respectively. The corrected mileage data is non-decreasing and exhibits a linear trend line.

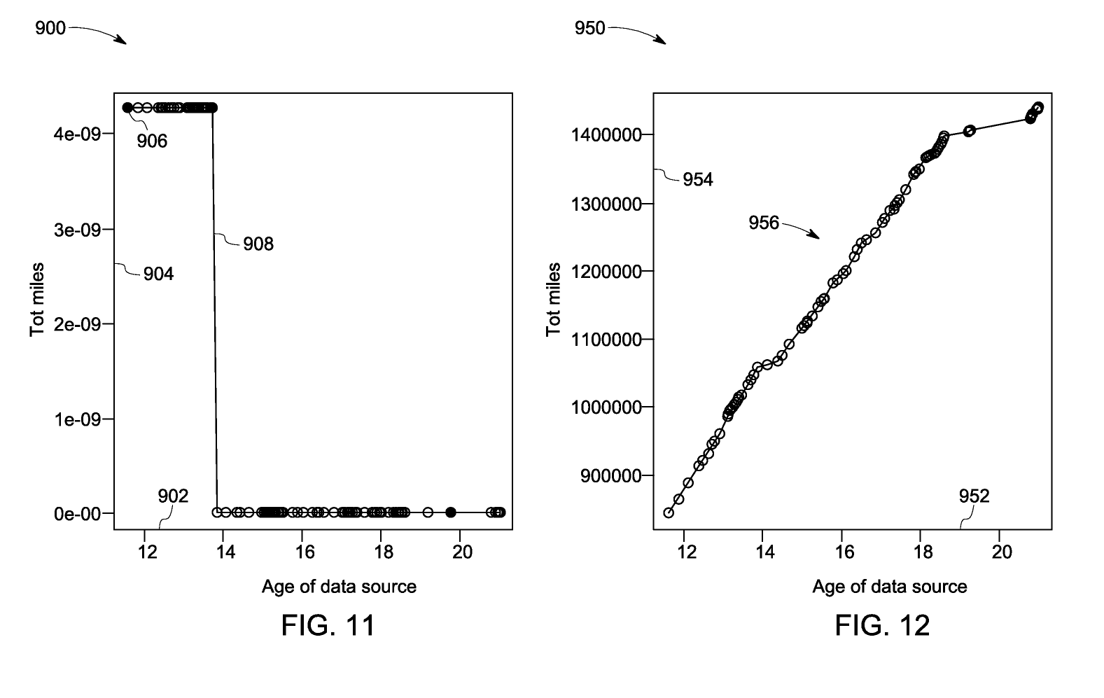

FIG. 11 is a graph 900 illustrating a curve 908 representative of a data source mileage data with an intercept event in accordance with an exemplary embodiment. The x-axis 902 is indicative of time in years representative of age of the data source and y-axis 904 is indicative of distance in miles representative of distance traveled by the data source. The curve 908 illustrates a data sample 906 with a very high intercept value (4e+09) deviating from an average intercept value (not shown) of a fleet from which measurement data is received. The intercept event at the data sample 906 is corrected by replacing the curve 908 by a curve (shown in the subsequent graph) representative of an average of the mileage data of the fleet of data sources.

FIG. 12 is a graph 950 representative of a correction applied to the intercept event in accordance with the exemplary embodiment of FIG. 11. The x-axis 952 is indicative of time in years representative of age of the data source and y-axis 954 is indicative of distance in miles representative of distance traveled by the data source. The graph 950 illustrates a curve 956 illustrates the average of the mileage data of the fleet of data sources. The curve 908 is replaced by the curve 956 to correct the intercept error. It may be observed that the y-axis 954 is different from the y-axis 904 as the intercept value of the curve 908 is replaced by fleet level average data.

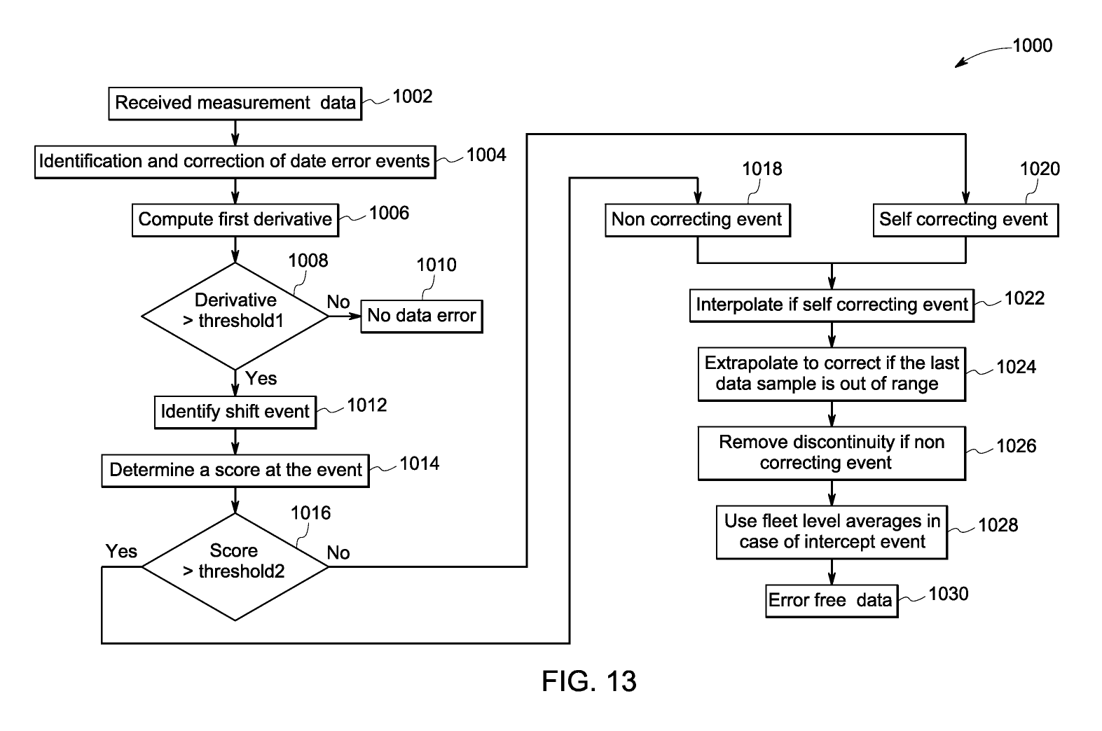

FIG. 13. is a flow chart 1000 illustrating steps involved in the exemplary statistical data correction technique applied to a measurement data received from a data source in accordance with an exemplary embodiment. In the illustrated embodiment, the received measurement data 1002 may be an operational parameter of a self-propelled vehicle such as a locomotive. The operational parameter may be a monotonically non-decreasing time series data representative of at least one of mileage, consumed power, and idle hours of the vehicle. The received measurement data may have one or more types of errors. The event at which a date error occurs is identified as a date error event. The date error event is identified based on a service introduction date, and a service completion date (or a data retrieval date) of the data source. Thereafter, identification of date error events and correction of date errors 1004 in the measurement data is performed. The processing of received measurement data for correcting date errors involves correcting at least one of a missing date of operation of the data source, correcting a first date prior to the service introduction date of the data source, and correcting a second date after the service completion date (or the data retrieval date) of the data source.

A first derivative of the data samples of the measurement data after the date correction is computed 1006. Thereafter, the first derivative is compared with a first threshold value 1008. If the first derivative corresponding to a data sample is greater than the first threshold value, an event is identified at the corresponding data sample and the time instant corresponding to the data sample is recorded 1012. If the first derivative is lesser than the first threshold value, the measurement data at the corresponding data sample is considered as error free data 1010.

For each of the identified event, a score value is determined 1014 based on the date corrected measurement data and the identified event. The score value is determined by constructing a secant line at the identified event, determining a slope of the secant line using equation (1), and by computing a statistical value based on the determined slope value using equation (2). The score value is then compared with a second threshold value 1016 and an event category of the identified event is determined based on the comparison. If the score value is greater than the second threshold value, the identified event is determined as a non-correcting event 1018. If the score value is lesser than or equal to the second threshold value, the identified event is determined as a self-correcting event 1020.

The measurement data is processed based on the determined event category to correct one or more errors. Furthermore, events are corrected according to the following sequence including self-correcting event, an out of range event, a non-correcting event, and an intercept event. The measurement data is interpolated 1022 at the self-correcting event to correct a self-correcting error. If the identified event corresponds to the last data sample among the plurality of data samples, an out-of-range event is identified and the measurement data is extrapolated 1024 to correct the error. In the case of the non-correcting event, the measurement data is processed to remove the discontinuity 1026. If the identified event is an intercept event, the intercept value of the measurement data of the data source is replaced by a fleet level average data 1028 to correct the error condition. The processed data 1030 is free of date errors and shift errors.

The exemplary statistical data correction technique facilitates to build accurate reliability models of the data source. When the data source is a self-propelled vehicle such as locomotives, for example, the exemplary statistical data correction technique provide inputs to models that competitively price and predict the short and long term profitability of maintenance contract associated with the vehicle.

It is to be understood that not necessarily all such objects or advantages described above may be achieved in accordance with any particular embodiment. Thus, for example, those skilled in the art will recognize that the systems and techniques described herein may be embodied or carried out in a manner that achieves or improves one advantage or group of advantages as taught herein without necessarily achieving other objects or advantages as may be taught or suggested herein.

While the technology has been described in detail in connection with only a limited number of embodiments, it should be readily understood that the invention are not limited to such disclosed embodiments. Rather, the technology can be modified to incorporate any number of variations, alterations, substitutions or equivalent arrangements not heretofore described, but which are commensurate with the spirit and scope of the claims. Additionally, while various embodiments of the technology have been described, it is to be understood that aspects of the inventions may include only some of the described embodiments. Accordingly, the inventions are not to be seen as limited by the foregoing description, but are only limited by the scope of the appended claims.

What is claimed as new and desired to be protected by Letters Patent of the United States is:

1. A method comprising:
receiving measurement data representative of an operational parameter from a data source, wherein the operational parameter comprises a monotonous time series data;
identifying an event based on the measurement data;
determining an event category based on the identified event; and
processing the measurement data using a statistical data correction technique, based on the determined event category, to generate a corrected data for deriving a decision related to the data source.

2. The method of claim 1, wherein the data source comprises a vehicle; wherein the operational parameter comprises at least one of mileage, consumed power, and idle hours of the vehicle.

3. The method of claim 1, wherein the identifying comprises determining a data sample of the measurement data, having an associated date error.

4. The method of claim 1, wherein the identifying comprises:
determining a first derivative of each data sample among a plurality of data samples of the measurement data;
comparing the first derivative of each data sample with a first threshold value; and
determining a time instant value of the corresponding data sample if the first derivative of the corresponding data sample is greater than the first threshold value.

5. The method of claim 4, wherein the determining the event category comprises:
determining a secant line based on the time instant value;
determining a slope of the secant line;
determining a score value based on the slope;
comparing the score value with a second threshold value; and
determining the event category based on the comparison of the score value with the second threshold value.

6. The method of claim 5, wherein the first threshold value is equal to the second threshold value.

7. The method of claim 4, wherein the identifying further comprises determining the event as a shift event if the first derivative of the corresponding data sample is greater than the first threshold value.

8. The method of claim 1, wherein the event category comprises at least one of a self-correcting event, a non-correcting event, an out-of-range event, an intercept event, and a date error event.

9. The method of claim 8, wherein the processing comprises interpolating the measurement data if the determined event category is the self-correcting event.

10. The method of claim 8, wherein the processing comprises removing a discontinuity in the measurement data if the determined event category is the non-correcting event.

11. The method of claim 8, wherein the processing comprises replacing an intercept value of the measurement data by a fleet level average data if the determined event category is the intercept event.

12. The method of claim 8, wherein the processing comprises extrapolating the measurement data if the determined event category is the out-of-range event.

13. The method of claim 1, wherein the processing comprises at least one of including a missing date of operation of the data source, correcting a first date prior to a service introduction date of the data source, and correcting a second date after a service completion date of the data source or a data retrieval date.

14. A system comprising:
a processor based device configured to:
receive measurement data representative of an operational parameter from a data source, wherein the operational parameter comprises a monotonous time series data;
identify an event based on the measurement data;
determine an event category based on the identified event; and
process the measurement data using a statistical data correction technique, based on the determined event category, to generate a corrected data for deriving a decision related to the data source.

15. The system of claim 14, wherein the processor based device is configured to determine a data sample of the measurement data, having an associated date error.

16. The system of claim 14, wherein the processor based device is configured to identify the event by:
determining a first derivative of each data sample among a plurality of data samples of the measurement data;
comparing the first derivative of each data sample with a first threshold value; and
determining a time instant value of the corresponding data sample if the first derivative of the corresponding data sample is greater than the first threshold value.

17. The system of claim 16, wherein the processor based device is further configured to determine the event category by:
determining a secant line based on the time instant value;
determining a slope of the secant line;
determining a score value based on the slope;
comparing the score value with a second threshold value; and
determining the event category based on the comparison of the score value with the second threshold value.

18. The system of claim 14, wherein the event category comprises at least one of a non-correcting event, a self-correcting event, an out-of-range event, and a date error event.

19. The system of claim 18, wherein the processor based device is configured to process the measurement data by interpolating the measurement data if the determined event category is the self-correcting event.

20. The system of claim 18, wherein the processor based device is configured to process the measurement data by removing a discontinuity in the measurement data if the determined event category is the non-correcting event.

21. The system of claim 18, wherein the processor based device is configured to process the measurement data by replacing an intercept value of the measurement data by a fleet level average data if the determined event category is an intercept event.

22. The system of claim 18, wherein the processor based device is configured to process the measurement data by extrapolating the measurement data if the determined event category is the out-of-range event.

23. The system of claim 14, wherein the processor based device is configured to process the measurement data by performing at least one of including a missing date of operation of the data source, correcting a first date prior to a service introduction date of the data source, and correcting a second date after a service completion date of the data source or a data retrieval date.

24. A non-transitory computer readable medium encoded with a program to instruct a processor based device to:
receive measurement data representative of an operational parameter from a data source, wherein the operational parameter comprises a monotonous time series data;
identify an event based on the measurement data;
determine an event category based on the identified event; and
process the measurement data using a statistical data correction technique, based on the determined event category, to generate a corrected data for deriving a decision related to the data source.
